(19) United States
(12) Patent Application Publication
(10) Pub. No.: US 2011/0304799 A1
(43) Pub. Date: Dec. 15, 2011

(54) Polymer-dispersed liquid crystal display device and method of manufacturing the same

(75) Inventors: Gae-hwang Lee, Hwaseong-si (KR); Jae-eun Jang, Seoul (KR); Kyu-young Hwang, Ansan-si (KR); Jae-eun Jung, Seoul (KR)

(73) Assignee: Samsung Electronics Co., Ltd., Suwon-si (KR)

(21) Appl. No.: 13/064,606

(22) Filed: Apr. 4, 2011

(30) Foreign Application Priority Data
Jun. 11, 2010 (KR) 10-2010-0055465

(51) Int. Cl. G02F 1/1334; C08J 7/18

(52) U.S. Cl. 349/86; 427/508; 427/514

(57) ABSTRACT

A polymer-dispersed liquid crystal (PDLC) display device includes a first substrate having a reflective layer on a surface thereof and a second substrate facing the first substrate. A first electrode and a second electrode may be formed on inner surfaces of the first and second substrates, and a PDLC layer may be between the first substrate and the second substrate. The PDLC layer may include a first liquid crystal layer region including dispersed polymers and liquid crystals, and a second liquid crystal layer region between the first liquid crystal layer region and the second substrate, the second liquid crystal layer region not including polymers.

### CROSS-REFERENCE TO RELATED APPLICATIONS

This application claims the benefit of Korean Patent Application No. 10-2010-0055465, filed on Jun. 11, 2010, in the Korean Intellectual Property Office, the entire contents of which are incorporated herein by reference.

### BACKGROUND

1. Field

Example embodiments relate to polymer-dispersed liquid crystal display devices and methods of manufacturing the devices, and more particularly, to polymer-dispersed liquid crystal display devices that may reduce surface scattering and methods of manufacturing the devices.

2. Description of the Related Art

Polymer-dispersed liquid crystals (PDLCs) are in a state where polymers and liquid crystals are distributed evenly, and a PDLC display device is a display device for scattering or transmitting light by using a characteristic that an optical refractive index between the polymers and the liquid crystals is changed according to an electric field. When a voltage is not applied to the PDLCs, the liquid crystals are irregularly arranged, and thus, incident light may be scattered due to a difference between refractive indexes of the polymers and the liquid crystals. When a voltage is applied to the PDLCs, the liquid crystals are arranged, and then, the refractive indexes of the polymers and the liquid crystals become the same as each other and the incident light transmits through the PDLC display device.

According to the above principle, a PDLC dye including a dichroic dye absorbs or transmits the light. When the PDLC dye is scattered, the PDLCs scatter the incident light and the dye absorbs the light to shield the light. In addition, in a transmission status of the PDLC dye, the dye transmits the light without absorbing the light so that the light reflected by a reflection plate may be incident to the eyes of a user. If an amount of the dye increases in the PDLC dye, the transmittance of the light degrades and the reflective rate also decreases, and thus, the smallest possible amount of light should be absorbed by a dye.

On the other hand, some of the incident light does not reach the reflection plate, and is scattered and reflected by a surface of the PDLCs. The surface scattered light may be about 10% to 40% of all of the reflected light. When the amount of the surface scattered light is reduced, the reflectivity may be reduced in the scattering mode, and thus, a visibility of the PDLC display device may be improved. In addition, in the conventional PDLC dye, the dye exists in the polymers, as well as between the liquid crystals. The dye existing between the liquid crystals rotates according to the electric field and changes an absorption rate of the light, and thus, the visibility is improved. However, the dye existing in the polymers does not rotate according to the electric field, and thus, the visibility of the PDLC display device degrades.

### SUMMARY

Provided are polymer-dispersed liquid crystal (PDLC) display devices that may reduce light that is scattered and reflected by a surface of the PDLC display devices thereby avoiding a reflection plate and improving visibility thereof, and methods of manufacturing the PDLC display devices. Additional aspects will be set forth in part in the description which follows and, in part, will be apparent from the description, or may be learned by practice of example embodiments.

According to example embodiments, a polymer-dispersed liquid crystal (PDLC) display device may include a reflective layer on a surface of a first substrate; a second substrate facing the first substrate; a first electrode and a second electrode on inner surfaces of the first and second substrates, respectively; and a PDLC layer between the first substrate and the second substrate, the PDLC layer including a first liquid crystal layer region including dispersed polymers and liquid crystals, and a second liquid crystal layer region between the first liquid crystal layer region and the second substrate, the second liquid crystal layer region not including polymers.

The first liquid crystal layer region and the second liquid crystal layer region may not be separate from each other. The first liquid crystal layer region and the second liquid crystal layer region may include dichroic dye, and the dichroic dye does not exist in the polymers. The PDLC device may further include a polymer supporter on at least one of the first substrate and the second substrate, the polymer supporter adhering the first and second substrates to each other.

According to example embodiments, a method of manufacturing a polymer-dispersed liquid crystal (PDLC) display device may include forming a first reflective layer on a surface of a first substrate; injecting a mixture solution between the first substrate and a temporary substrate, the mixture solution including a photocurable material and liquid crystals; and forming a PDLC layer including forming first liquid crystal layer region by exposing the mixture solution to ultraviolet rays in order to cure the photocurable material, the first liquid crystal layer region including dispersed polymers and the liquid crystals, removing the temporary substrate and forming a second substrate spaced apart from the first liquid crystal layer region, and forming a second liquid crystal layer region by injecting the liquid crystals into a space between the first liquid crystal layer region and the second substrate, the second liquid crystal layer region not including polymers.

Injecting the liquid crystals may include injecting a dichroic dye into the first liquid crystal layer region such that the liquid crystals of the first liquid crystal layer region and the second liquid crystal layer region include the dichroic dye. The temporary substrate may be a release paper. The method may further include forming a second reflective layer on a surface of the temporary substrate. Removing the temporary substrate may include dividing the first liquid crystal layer region including the polymers and the liquid crystals into halves in order to form two PDLC display devices by performing the first liquid crystal layer region forming process once.

The method may further include forming a second reflective layer on a surface of the temporary substrate. The method may further include forming a polymer supporter on at least one of the first and second substrates in order to adhere the first and second substrates to each other.

A polymer-dispersed liquid crystal (PDLC) layer is configured in such a way that a second liquid crystal layer region including liquid crystals, but not polymers, may be disposed on a first liquid crystal layer region including polymers and liquid crystals, and thus scattering and reflection of light is reduced on a surface of the PDLC layer. In addition, liquid crystals including dichroic dye are injected during formation of the second liquid crystal layer, and thus, there is no dye in a polymer of the PDLC layer, thereby improving visibility.

### BRIEF DESCRIPTION OF THE DRAWINGS

These and/or other aspects will become apparent and more readily appreciated from the following description of example embodiments, taken in conjunction with the accompanying drawings of which:

FIG. 1 is a schematic cross-sectional view of a polymer-dispersed liquid crystal (PDLC) display device according to example embodiments;

FIGS. 2 through 5 are diagrams illustrating a method of manufacturing the PDLC display device, according to example embodiments;

FIGS. 6A and 6B are diagrams illustrating operating states of the PDLC display device according to example embodiments;

FIGS. 7A and 7B are diagrams illustrating a principle of operating liquid crystals including a dichroic dye, according to example embodiments; and

FIGS. 8A and 8B are cross-sectional views showing examples of a supporter for fixing a first substrate and a second substrate in the PDLC display device according to example embodiments.

### DETAILED DESCRIPTION

Reference will now be made in detail to embodiments, examples of which are illustrated in the accompanying drawings, wherein like reference numerals refer to like elements throughout. In this regard, example embodiments may have different forms and should not be construed as being limited to the descriptions set forth herein. Accordingly, example embodiments are merely described below, by referring to the figures, to explain aspects of the present description.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “and/or” includes any and all combinations of one or more of the associated listed items.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

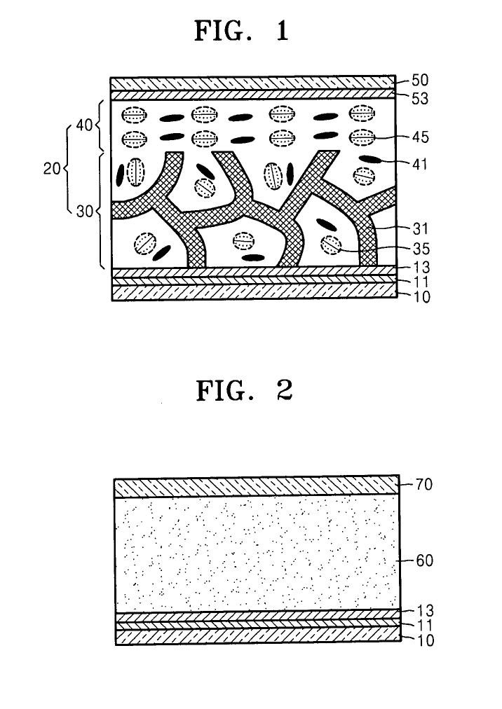

FIG. 1 is a schematic cross-sectional view of a polymer-dispersed liquid crystal (PDLC) display device according to example embodiments. The PDLC display device of example embodiments may include a plurality of pixels, each of which is a base unit for displaying images, like other display devices. In addition, each of the pixels may include blue, green, and red sub-pixels for realizing colors. In addition, a color filter (not shown) for realizing colors may be formed.

Referring to FIG. 1, the PDLC display device includes a first substrate 10 and a second substrate 50 disposed facing each other, a first electrode 13 and a second electrode 53 that are respectively formed on inner surfaces of the first and second substrates 10 and 50 facing each other, and a PDLC layer 20 disposed between the first and second substrates 10 and 50. The PDLC layer 20 includes a first liquid crystal layer region 30 including dispersed polymers 31 and liquid crystals 35, and a second liquid crystal layer region 40 that is located between the first liquid crystal layer region 30 and the second substrate 50 and includes liquid crystals 45 without polymers.

The first substrate 10 has a reflective layer 11 for reflecting incident light. When the reflective layer 11 is formed on the inner surface of the first substrate 10, that is, a surface facing the PDLC layer 20 (an upper surface of the first substrate 10 in FIG. 1), the first substrate 10 may be a transparent or opaque substrate. When the reflective layer 11 is formed on an outer surface of the first substrate 10 (a lower surface of the first substrate 10 in FIG. 1), the first substrate 10 may be a transparent substrate. The second substrate 50 may be a transparent substrate. The first and second substrates 10 and 50 may be formed of, for example, glass or plastic; however, example embodiments are not limited to these examples, and the first and second substrates 10 and 50 may be formed of various materials.

The first and second electrodes 13 and 53 may be respectively formed on the inner surfaces of the first and second substrate 10 and 50, which face each other. When the reflective layer 11 is formed on the inner surface of the first substrate 10, the reflective layer 11 may be disposed on the first substrate 10, and the first electrode 13 may be disposed on the reflective layer 11. The first and second electrodes 13 and 53 may be formed of a transparent conductive material, for example, indium tin oxide (ITO). Instead of forming both the first electrode 13 and the reflective layer 11, the first electrode 13 may perform also as a reflective layer without forming the reflective layer 11.

In a passive matrix (PM) type display device, the first electrode 13 may be formed as stripes arranged parallel with each other, and the second electrode 53 may be formed as stripes crossing the first electrode 13. In addition, in an active matrix (AM) type display device, the second electrode 53 may be a common electrode, and the first electrode 13 may be formed to correspond to the pixels or sub-pixels. In the AM type display device, a thin-film transistor (TFT) and driving lines may be formed on the first substrate 10 together with the first electrode 13, although it is not shown in FIG. 1.

As described above, the PDLC layer 20 may be disposed between the first and second substrates 10 and 50, and may include the first liquid crystal layer region 30 and the second liquid crystal layer region 40. The first liquid crystal layer region 30 includes the dispersed polymers 31 and the liquid crystals 35 filled in spaces between the polymers 31. The first liquid crystal layer region 30 may be formed by mixing a photocurable material and liquid crystals, and curing the mixed solution (60 of FIG. 2) by using light, e.g., ultraviolet (UV) rays. The photocurable material may be a material that is able to be cured by light. The photocurable material may be at least one of a monomer, oligomer, and polymer. The second liquid crystal layer region 40 may only include the liquid crystals 45 without polymer. The first and second liquid crystal layer regions 30 and 40 are not separated by the polymers 31 or other materials.

The first and second liquid crystal layer regions 30 and 40 may further include a dichroic dye 41. When the dichroic dye 41 is mixed in the PDLC layer 20, the dichroic dye 41 may be arranged or randomly distributed by the movement of the liquid crystal, thereby causing an optical change. In the PDLC display device according to example embodiments, the dichroic dye 41 may only exist in the liquid crystals 35 and 45, and not exist in the polymers 31. Accordingly, degradation in visibility, which is generated in a conventional PDLC display device due to scattering of the light by a dichroic dye because the dichroic dye is not arranged with the movement of the liquid crystal, may not occur. That is, according to the PDLC display device of example embodiments, because the dichroic dye 41 only exists in the liquid crystals 35 and 45, the visibility of the PDLC display device may be improved.

FIGS. 2 through 5 schematically illustrate a method of manufacturing the PDLC display device, according to example embodiments. Referring to FIG. 2, when a distance between the first substrate 10 including the reflective layer 11 and the first electrode 13 on a surface thereof and a temporary substrate 70 is maintained by using a spacer (not shown), a solution in which a photocurable material and the liquid crystals have a homogeneous phase, that is, a mixture solution 60, may be injected into a space between the first electrode 10 and the temporary substrate 70. The temporary substrate 70 may be a substrate, e.g., a release paper. In addition, the temporary substrate 70 may substantially be the same substrate as the first substrate 10 that includes the reflective layer 11 and the first electrode 13.

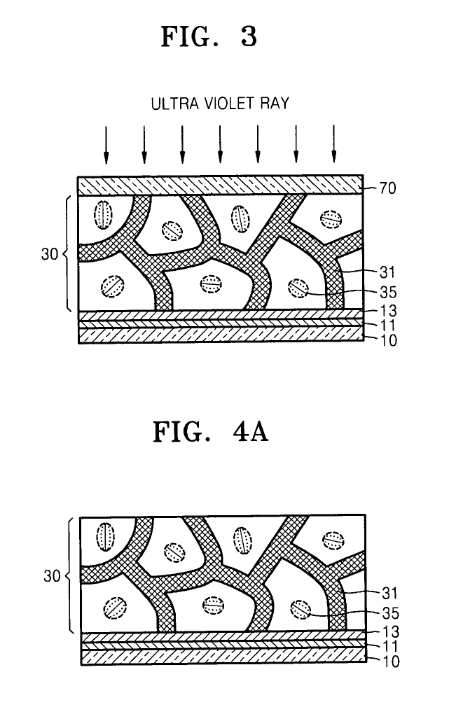

As shown in FIG. 3, UV rays may be irradiated onto the mixture solution 60 from an upper portion of the temporary substrate 70 in order to cure the photocurable material. As the UV rays are irradiated, the photocurable material may be cured into the polymers 31, and the first liquid crystal layer region 30, in which the liquid crystals 35 exists in spaces between the polymers 31, is formed.

As described above, when the first liquid crystal layer region 30 including the polymers 31 and the liquid crystals 35 is formed, a portion of the first liquid crystal layer region 30 that is opposite to the first substrate 10 is exposed.

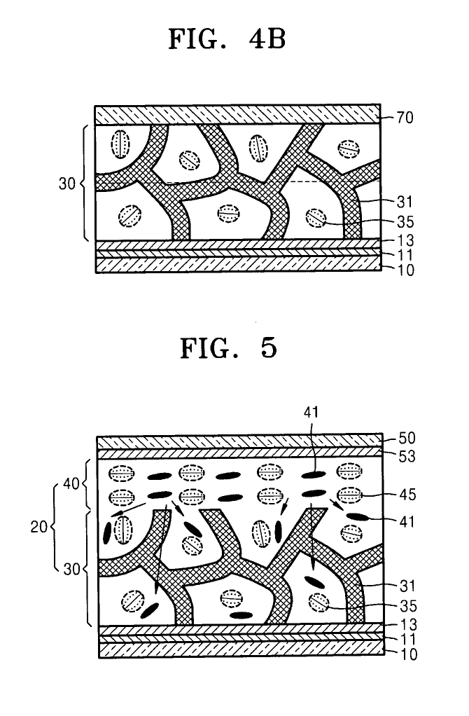

That is, when the release paper is used as the temporary substrate 70, the temporary substrate 70 is removed as shown in FIG. 4A, and the first liquid crystal layer region 30 may be exposed. Otherwise, when a substrate that is substantially the same as the first substrate 10 is used as the temporary substrate 70, the first liquid crystal layer region 30 is divided into halves so that a pair of structures, in which the first liquid crystal layer regions 30 are formed on the first substrate 10 as shown in FIG. 4B, may be formed when the temporary substrate 70 is removed. As described above, if the process of using substantially the same substrate as the first substrate 10 and dividing the first liquid crystal layer region 30 into halves is performed, base structures for forming two PDLC display devices may be obtained by performing the first liquid crystal layer region 30 forming process once.

The second substrate 50 may be located by using a spacer (not shown) that is greater than the thickness of the first liquid crystal layer region 30 so that a space may exist between the second substrate 50 and the first liquid crystal region 30, and the liquid crystals 45 are injected into the space. The second liquid crystal layer region 40 that does not include the polymers may be formed on the first liquid crystal layer region 30.

Through the above processes, the PDLC layer 20 that includes the first liquid crystal layer region 30 including the dispersed polymers 31 and the liquid crystals 35 and the second liquid crystal layer region 40 including the liquid crystals 45 without polymers may be formed between the first and second substrates 10 and 50.

On the other hand, the PDLC layer 20 may further include the dichroic dye 41, and at this time, the dichroic dye 41 may be included in the liquid crystals 45 that are injected to form the second liquid crystal layer region 40 in order for the polymers 31 not to include the dichroic dye 41. In example embodiments, the dichroic dye 41 included in the liquid crystals 45 that are injected to form the second liquid crystal layer region 40 may be dispersed into the first liquid crystal layer region 30 that does not include the dichroic dye 41. Thus, the dichroic dye 41 may exist in the liquid crystals 35 of the first liquid crystal layer region 30. A temperature may be increased in order to help the dichroic dye 41 disperse into the first liquid crystal layer region 30.

As described above, when the liquid crystals 45 including the dichroic dye 41 are injected in the process of forming the second liquid crystal layer region 40, the dichroic dye 41 does not exist in the polymers 31 that are already cured. Thus, the degradation of visibility caused by the scattering of the dichroic dye 41 in the polymers 31 does not occur, and thus, the visibility of the PDLC display device may be improved. In example embodiments, the dichroic dye 41 may have a black, yellow, magenta, red, green, or blue color; however, example embodiments are not limited to these examples.

As described above, the PDLC display device according to example embodiments may be formed by forming the PDLC layer that does not include the dichroic dye, and injecting liquid crystals including the dichroic dye into the PDLC layer. Of course, the dichroic dye may be included in the PDLC layer when the PDLC layer is formed.

According to the PDLC display device and the method of manufacturing the PDLC display device of example embodiments, the second liquid crystal layer region 40 that does not include polymers may be disposed on the first liquid crystal layer region 30 that includes the polymers 31. Thus, the polymers do not exist on the surface of the PDLC layer 20. Therefore, the scattering of light caused by the polymers does not occur on the surface of the PDLC layer 20.

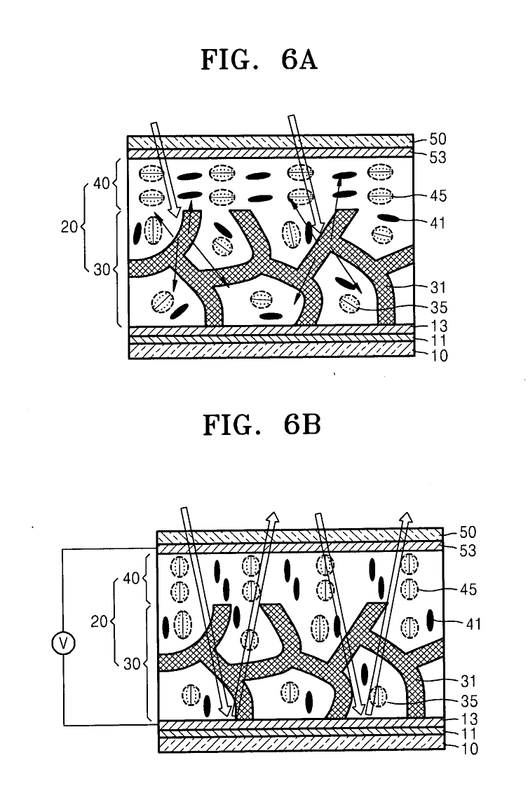

FIGS. 6A and 6B illustrate operating states of the PDLC display device according to example embodiments. Referring to FIG. 6A, when a voltage is not applied to the PDLC layer 20, some of the incident light may be absorbed by the dichroic dye 41 that is randomly arranged in the second liquid crystal layer region 40 and the remaining incident light transmits through the second liquid crystal layer region 40 and reaches the first liquid crystal layer region 30 including the polymers 31 and the dichroic dye 41.

When the voltage is not applied to the PDLC layer 20, the second liquid crystal layer region 40 including the dichroic dye 41 does not scatter the incident light or only scatters a small amount of the light. The light reaching the first liquid crystal layer region 30 may be scattered by the polymers 31 to be absorbed and partially reflected. The scattered light may be absorbed by the dichroic dye 31 that is arranged randomly, and some of the scattered light may be reflected to the second liquid crystal layer region 40. The scattered and reflected light may be absorbed by the second liquid crystal layer region 40 again.

Referring to FIG. 6B, when a voltage is applied to the PDLC layer 20, the liquid crystals 35 and 45 in the first and second liquid crystal layer regions 30 and 40 may be arranged in a direction, and the dichroic dye 41 may also be arranged in a direction of the liquid crystals 35 and 45. Therefore, the incident light transmits through the second liquid crystal layer region 40 and the first liquid crystal layer region 30 without being absorbed by the dichroic dye 41, and is reflected by the reflective layer 11 toward the second substrate 50.

As shown in FIGS. 6A and 6B, the second liquid crystal layer region 40 that does not include the polymers may always be in the transmission mode, unlike the first liquid crystal layer region 30 including the polymers 31. Therefore, the light may be less scattered on the surface of the PDLC layer 20, as compared with a case where the polymers exist throughout the entire region of the PDLC layer.

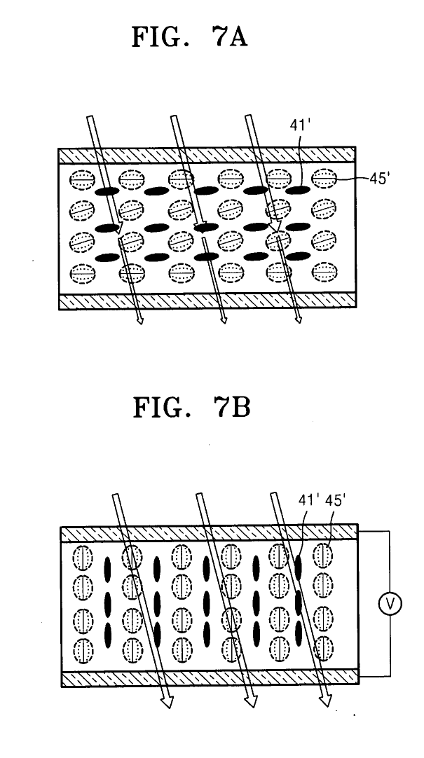

FIGS. 7A and 7B illustrate a principle of driving liquid crystals 45′ including a dichroic dye 41′, according to example embodiments. Referring to FIG. 7A, when a voltage is not applied to a liquid crystal layer, some of the incident light may be absorbed by the dichroic dye 41′ that is randomly arranged, and thus, an amount of light transmitting through the liquid crystal layer may be reduced.

Referring to FIG. 7B, when a voltage is applied to the liquid crystal layer, the dichroic dye 41′ may also be arranged according to the arrangement of the liquid crystals 45′. Thus, the incident light may not be absorbed by the dichroic dye 41′, and most of the light transmits through the liquid crystal layer.

On the other hand, according to the PDLC display device according to example embodiments, because the second liquid crystal layer region 40 is not an adhesive because the second liquid crystal layer region 40 does not include polymers, the first and second substrates 10 and 50 may not be fixed to each other.

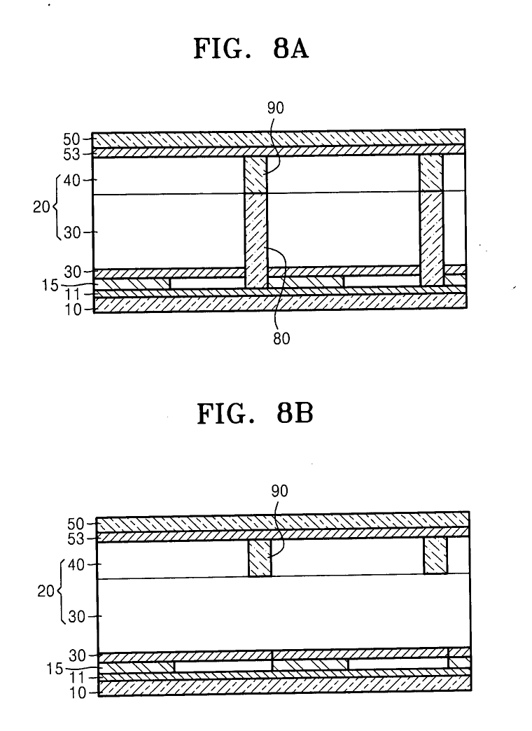

FIGS. 8A and 8B illustrate examples of supporters 80 and 90 for fixing the first substrate 10 and the second substrate 50 in the PDLC display device according to example embodiments. As shown in FIG. 8A, when the supporters 80 and 90 are formed on the first and second substrates 10 and 50 respectively, the PDLC layer 20 including the first and second liquid crystal layer regions 30 and 40 may be formed between the first and second substrates 10 and 50 according to the processes described with reference to FIGS. 2 through 5. The supporters 80 and 90 on the first and second substrates 10 and 50 may be bonded to each other, and thus, the first and second substrates 10 and 50 may be fixed to each other.

In addition, as shown in FIG. 8B, the supporter 90 may not be formed on the first substrate 10 because the first liquid crystal layer region 30 includes the polymers. The supporter 90 may be formed on the second substrate 50. The supporter 90 of the second substrate 50 may be bonded to the polymers 31 in the first liquid crystal layer region 30, and thus, the first and second substrates 10 and 50 may be fixed to each other. In FIGS. 8A and 8B, the supporters 80 and 90 may be formed of at least one of a thermosetting material and a photocurable material. For example, the supporters 80 and 90 may be polymer supporters. In FIGS. 8A and 8B, reference numeral 15 denotes a TFT.

The structure of the PDLC display device having the supporters 80 and 90 for fixing the first and second substrates 10 and 50 to each other according to example embodiments are not limited to the structures shown in FIGS. 8A and 8B, and may be modified variously.

It should be understood that example embodiments described therein should be considered in a descriptive sense only and not for purposes of limitation. Descriptions of features or aspects within each example embodiment should typically be considered as available for other similar features or aspects in other example embodiments.

What is claimed is:

1. A polymer-dispersed liquid crystal (PDLC) display device comprising:
a reflective layer on a surface of a first substrate;
a second substrate facing the first substrate;
a first electrode and a second electrode on inner surfaces of the first and second substrates, respectively; and
a PDLC layer between the first substrate and the second substrate, the PDLC layer including,
a first liquid crystal layer region including dispersed polymers and liquid crystals, and
a second liquid crystal layer region between the first liquid crystal layer region and the second substrate, the second liquid crystal layer region not including polymers.

2. The PDLC display device of claim 1, wherein the first liquid crystal layer region and the second liquid crystal layer region are not separate from each other.

3. The PDLC display device of claim 1, wherein the first liquid crystal layer region and the second liquid crystal layer region include dichroic dye.

4. The PDLC display device of claim 3, wherein the dichroic dye does not exist in the polymers.

5. The PDLC device of claim 1, further comprising:
a polymer supporter on at least one of the first substrate and the second substrate, the polymer supporter adhering the first and second substrates to each other.

6. A method of manufacturing a polymer-dispersed liquid crystal (PDLC) display device, the method comprising:
forming a first reflective layer on a surface of a first substrate;
injecting a mixture solution between the first substrate and a temporary substrate, the mixture solution including a photocurable material and liquid crystals; and
forming a PDLC layer including,
forming first liquid crystal layer region by exposing the mixture solution to ultraviolet rays in order to cure the photocurable material, the first liquid crystal layer region including dispersed polymers and the liquid crystals,
removing the temporary substrate and forming a second substrate spaced apart from the first liquid crystal layer region, and
forming a second liquid crystal layer region by injecting the liquid crystals into a space between the first liquid crystal layer region and the second substrate, the second liquid crystal layer region not including polymers.

7. The method of claim 6, wherein the injecting the liquid crystals includes injecting a dichroic dye into the first liquid crystal layer region such that the liquid crystals of the first liquid crystal layer region and the second liquid crystal layer region include the dichroic dye.

8. The method of claim 7, wherein the temporary substrate is a release paper.

9. The method of claim 6, wherein the temporary substrate is a release paper.

10. The method of claim 7, further comprising:
forming a second reflective layer on a surface of the temporary substrate.

11. The method of claim 10, wherein the removing the temporary substrate includes dividing the first liquid crystal layer region including the polymers and the liquid crystals into halves in order to form two PDLC display devices by performing the first liquid crystal layer region forming process once.

12. The method of claim 6, further comprising:
forming a second reflective layer on a surface of the temporary substrate.

13. The method of claim 12, wherein the removing the temporary substrate includes dividing the first liquid crystal layer region including the polymers and the liquid crystals into halves in order to form two PDLC display devices by performing the first liquid crystal layer region forming process once.

14. The method of claim 6, further comprising:
forming a polymer supporter on at least one of the first and second substrates in order to adhere the first and second substrates to each other.
